(19) United States
(12) Patent Application Publication
(10) Pub. No.: US 2018/0300667 A1
(43) Pub. Date: Oct. 18, 2018

(54) JOB ESTIMATE, PRODUCTION, AND COST MANAGEMENT SYSTEM

(71) Applicant: Tri Force Management Applications, LLC, Urbandale, IA (US)

(72) Inventor: Kevin Buckalew, Van Meter, IA (US)

(21) Appl. No.: 15/948,436

(22) Filed: Apr. 9, 2018

Related U.S. Application Data
(60) Provisional application No. 62/485,130, filed on Apr. 13, 2017.

(51) Int. Cl. G06Q 10/06; G06Q 30/02

(52) U.S. Cl. CPC G06Q 10/063114; G06Q 30/0283

(57) ABSTRACT

A job estimate, production, and cost management system includes a computer having stored information related to parts and labor needed to complete a project. A dashboard is related to the computer and adapted to permit a user to create a new job or project by selecting a portion of the stored information and creating an estimate based upon the selected information.

### CROSS REFERENCE TO RELATED APPLICATION

This application claims the benefit of U.S. Provisional Application No. 62/485,130 filed Apr. 13, 2017.

### BACKGROUND OF THE INVENTION

This invention is directed to an information management system and, more particularly, a system that provides job estimate, production, and cost management.

Estimating jobs can be complex, time consuming, and a labor intensive process. This process is complicated when a job involves multiple parts and labor where prices and rates frequently change. In addition, the process of tracking job progress and managing job costs can be overwhelming, time consuming, and labor intensive particularly where multiple jobs are in progress at one time.

There exists an overwhelming amount of information that utilizing conventional systems and methods lead to inefficiencies and inaccuracies in the process of quoting projects and managing projects to obtain a desirable profit. Therefore, a need exists in the art for a system that addresses these deficiencies.

An objective of the present invention is to provide an information management system that automatically adjusts for changes in prices and/or rates.

Another objective of the invention is to provide an information management system that manages an overwhelming amount of information for managing projects to obtain a desirable profit that is efficient and accurate.

These and other objectives will be apparent to those skilled in the art based upon the following written description, drawings, and claims.

### SUMMARY OF THE INVENTION

An information management system that provides job estimates, production, and cost management includes a computer having stored information related to parts and labor for completing a job or project. Associated with the computer is a dashboard that permits a use to create a new job or a project by selecting a portion of the stored information. The computer, using a processor and software, is adapted to create a job estimate based upon the selected portion of the stored information.

The dashboard is also adapted to permit the user to input information related to the completion of the job and used by the computer to create the estimate. In addition, the dashboard has one or more interfaces that permit third parties to provide information related to the completion of the job.

A user is able, through the dashboard, to select different types of estimates, create assembly groups, and create scope of work masters for future selection.

### BRIEF DESCRIPTION OF THE DRAWINGS

FIG. 1 is a schematic drawing of an information management system;

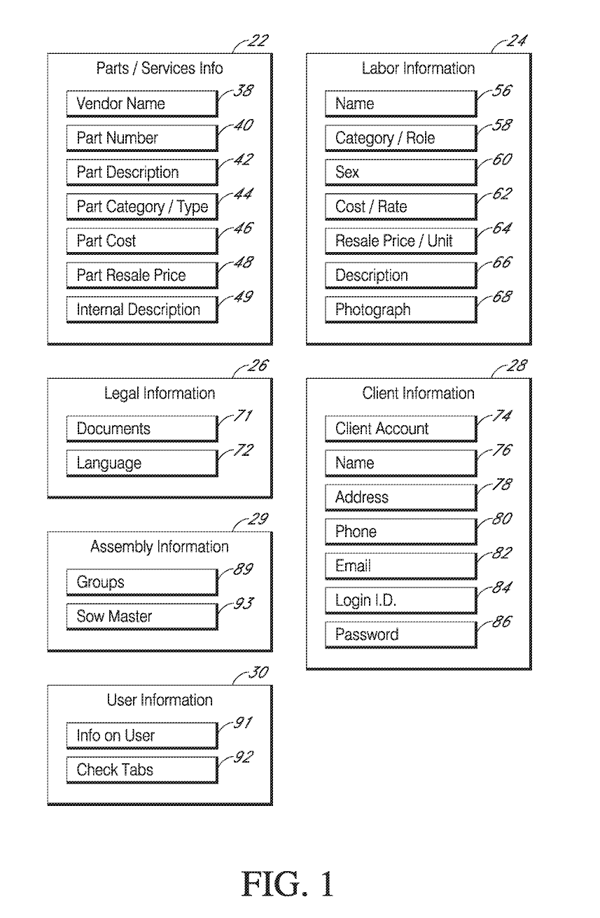

FIG. 2 is a schematic drawing of an information management system;

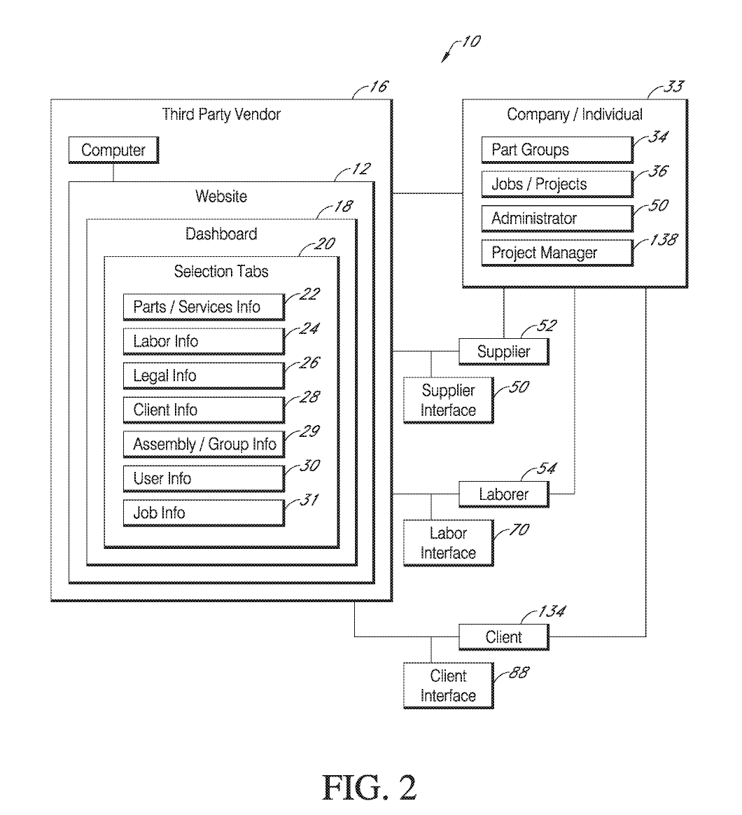

FIG. 3 is a top plan view of a dashboard for an information management system; and

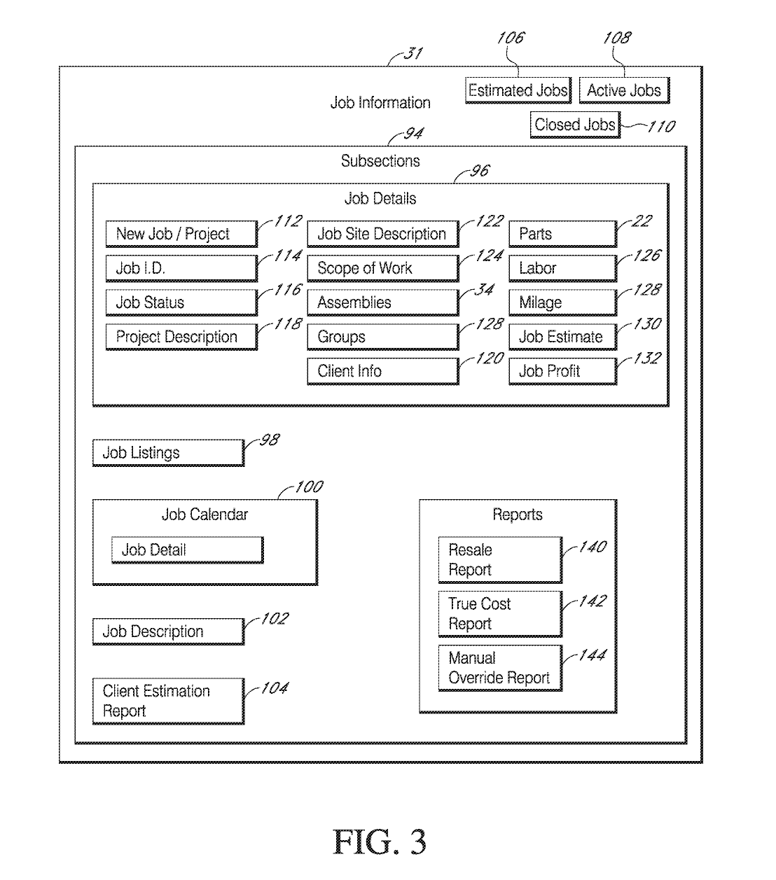

FIG. 4 is a schematic drawing of an information management system.

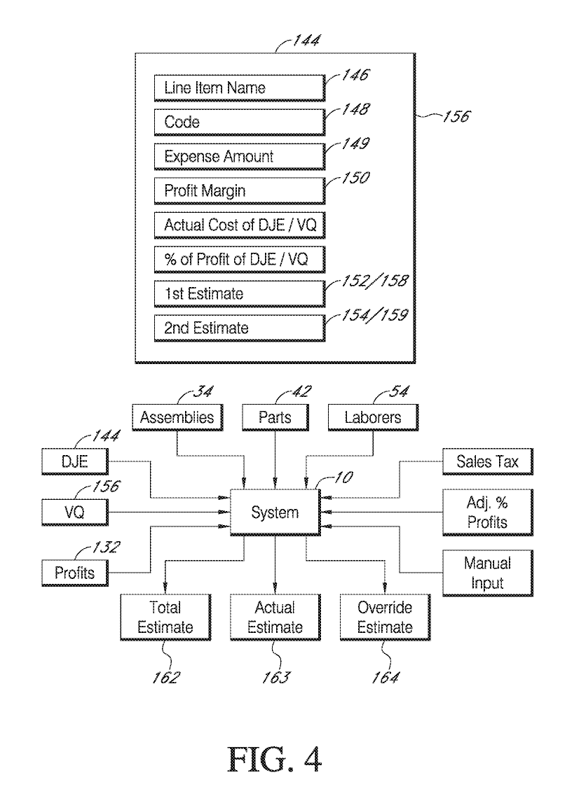

### DETAILED DESCRIPTION

Referring to the Figures, a job estimate, production, and cost management system 10 includes a website 12 connected to a computer 14 of a third-party vendor 16. The website 12 has a dashboard 18 having a plurality of selection tabs 20. As an example, the selection tabs 20 include, but are not limited to, tabs 20 for pars/services information 22, labor information 24, legal information 26, client information 28, assembly/group information 29, user information 30, and job information 31.

Parts/services information 22 permits a company or individual 32 to define, describe, and list parts and/or services used in the operation of the company 33. While the parts and services are listed individually, the company 33 can combine parts/services into groups/assemblies 34 for frequently or commonly performed jobs/projects 36. As an example, the parts/services information includes a vendor name 38, a part number 40, a description of the part 42, a part category or type 44, a purchase cost 46, and a resale price 48. A separate part description 42 may be used for internal 49 and customer use. Also, a supplier interface 50 is provided that permits a supplier 52 to import and update part information 22.

Labor information 24 permits a company/individual 32 to input, list, and assign a laborer 54, whether an individual, employee, contractor, or the like. An example of the labor information 24 includes the laborer's name 56, the laborer's category/role 58, the laborer's sex 60, their cost and/or rate 62, their resale price or unit 64, a specific description of the laborer 66, and a photograph 68 of the laborer. The website 12 may also have a labor interface 70 that permits a laborer 54 to apply for consideration by the company 32 and/or modify and update labor information 24.

Legal information 26 includes documents 71 and/or language 72 to be dropped into a contract that is relevant to a job and/or client.

Client information 28 is where the company or individual 32 creates and maintains a client account 74. As an example, client information 28 includes the client's name 76, address 78, phone 80, email 82, login ID 84, and password 86. The website 12 provides a client interface 88 for clients/customers to access relevant information and documents, such as, job progress, quotes and the like.

Assembly information 29 permits the company 32 to create part and labor groups 89 for frequently and commonly performed projects. The part and labor groups 89 are designed to make job creation and estimation easier and more simple by permitting quick access to groups 89. In addition, a scope of work group or master 93 can be created for frequent and common jobs or projects. The scope of work group or master 93 permits job information 31 and job details 96 that are likely to occur again to be saved in the computer. When the work group or master 93 is selected the stored job information 93 and job details 96 associated with the work group or master 93 is recalled and the associated fields are prepopulated.

User information 30 permits an administrator 90 of a company 32 to create and maintain user access and control at varying levels. Included is information 91 about a user (i.e., client, supplier, laborer, employee) and check tabs 92 that permit or restrict access to information.

Job information 31 has a plurality of subsections 94. The subsections 94, as an example, includes job details 96, job listings 98, job calendar 100, job description 102, and client estimation report 104. Job information 31 is separated by prospective or estimated jobs 106, active jobs 108, and closed jobs 110.

Job details 96 permit the company 32 to create a new job or project 112 for estimation, production, and billing. Job detail information that is input by the company 32 includes, as an example, a job I.D. 114, job status 116, project description 118, client information 120, directions to job site 122, scope of work 124, assemblies 34, groups 89, scope of work masters 93, and parts 22 to be used, labor needed 126, and estimated mileage 128. When inputting job details, the company is able to access and select information from parts information 22, labor information 24, legal information 26, client information 28, and assembly information 29. Based upon the information submitted to job details 96, the computer calculates an estimate 130 of the cost for each job 112 and the profit 132 for each job 112. Once calculated, legal documents 71 and/or language 72, as well as PDFs and other images, are added to the estimate 130. The estimate 130 is then printed and/or transmitted to the client 134 and the profit report 132 stored in the computer 14.

The job listings subsection 98 provides a list of all jobs 112 that can be viewed and edited by the company 32. The jobs calendar subsection 100 provides a display of all jobs 112. Preferably, the displays are color coded related to users assigned to the jobs 112. Shown is the length of the job and a tab 136 is provided to display job detail information when selected.

The job description subsection 102 provides a display of work to be performed and the parts and assemblies needed by the user. This information, provided in a report, is printed or transmitted to the authorized users. The client estimation report section 104 provides a display of jobs that have been estimated, the work to be performed, the estimated prices, and associated legal documentation.

Once an estimate is approved, the company 32 authorizes a laborer to begin work and parts are ordered and delivered to the job site where work is performed. As work is completed, information is updated in the system and an invoice is generated and transmitted to the client by the system.

Additional reports are producible by a project manager 138 or other administrator 90 via the management system 10. A resale report 140 provides a list of all costs and related markup. A true cost report 142 provides the quantity of assemblies 34, groups 89, and parts 22, along with the related profit and taxes. A manual override report 144 allows the project manager to manually enter entries while still providing calculated profit and loss. Each report is available on a client information 28 level or job detail 96 level.

The system 10 also provides a direct job expense 144 is enterable for any expense that is related to the job details 96 for a particular item. For example a direct job expense (DJE) 144 is related to a permit fee or the rental of equipment, such as a skid loader. When entering a direct job expense 144 a line item name 146 is entered along with a code 148 that relates to the type of direct job expense 144. Next an expense amount 149 is entered and then a profit margin 150 is entered. The system 10 then calculates the actual cost of direct job expense 144, percentages of profit 132 of the direct job expense 144. The system 10 also calculates a first estimate of the direct job expense 152, which includes all items within the job details 96 plus the profit 132. The system 10 also calculates a second estimate of the direct job expense 154, which includes all items within the job details 96 without profit 132.

The system 10 in another arrangement also provides a vendor quote expense 156 that is enterable for any expense provided by a vendor. The vendor quote expense 156, for example, is related to work completed by a vendor, such as a painter. For comparison, the direct job expense 144 is utilized for entering expenses related to the purchase of a particular paint, such as matter white paint, whereas the vendor quote expense 156 is utilized for entering expenses related to a painting vendor for twelve hours of work. Like the direct job expense 144, when entering a vendor quote expense 156 a line item name 146 is entered along with a code 148 that relates to the type of vendor quote expense. Next an expense amount 149 is entered and then a profit margin 150 is entered. The system 10 then calculates the actual cost of vendor quote expense 156, percentages of profit 132 of the vendor quote expense 156. The system 10 also calculates a first estimate of the vendor quote expense 158, which includes all items within the job details 96 plus the profit 132. The system 10 also calculates a second estimate of the vendor quote expense 159, which includes all items within the job details 96 without profit 132.

Additional estimations are provided via the system 10 in three different ways. A total estimation 160 by the system 10 provides an estimate based on all assemblies 34, parts 42, laborers 54, direct job expenses 144, and vendor quote expenses 156 with profits 132 and sales tax to provide the total estimation 162. An actual estimation 163 by the system 10 provides an estimate based on the actual cost for the assemblies 34, parts 42, laborers 54, direct job expenses 144, and vendor quote expenses 156 with an adjustable percentage of the profits 132 and sales tax to provide the actual estimation 163. In this way, the actual estimation 163 allows the total to be modified by adjusting the percentage of the profits 132. The system 10 also provides an override estimation 164 that permits the total estimate to be overridden and a total to be provided that is entered manually. The override estimation 164 allows a custom amount to be entered without respect to the actual costs associated to the assemblies 34, parts 42, laborers 54, direct job expenses 144, and vendor quote expenses 156 or profits 132 and sales tax.

What is claimed is:

1. A job estimate, production, and cost management system, comprising:
a computer having information stored including parts and labor related to completion of a job;
a dashboard related to the computer adapted to permit a user to create a new job by selecting a portion of the stored information; and
the computer adapted to create a job estimate based upon the selected portion of the stored information.

2. The system of claim 1 wherein the dashboard is adapted to permit the user to input information related to the completion of the job that is used by the computer to create the job estimate.

3. The system of claim 1 wherein the dashboard has one or more interfaces that permit third parties to provide the information related to completion of the job.

4. The system of claim 1 wherein the computer is adapted to provide more than one type of estimate.

5. The system of claim 1 wherein the dashboard is adapted to permit a user to create an assembly group based upon the stored information related to completion of the job.

6. The system of claim 2 wherein the dashboard is adapted to permit a user to create a scope of work master based upon the input information related to the completion of the job.

7. The system of claim 1 wherein the job estimate created by the computer is based upon an actual cost of the stored information and an adjustable percentage for profit.

8. The system of claim 1 wherein the estimate provided by the computer is overridden and entered manually to allow a custom amount to be entered without respect to the actual costs associated with information to complete the job.
